(19) United States
(12) Patent Application Publication
(10) Pub. No.: US 2022/0318846 A1
(43) Pub. Date: Oct. 6, 2022

(54) METHODS AND SYSTEMS FOR FACILITATING PROMOTION OF A CONTENT BASED ON PLAYING AN AUDIO

(71) Applicant: Steven Everett, Chicago, IL (US)

(72) Inventor: Steven Everett, Chicago, IL (US)

(21) Appl. No.: 17/707,783

(22) Filed: Mar. 29, 2022

Related U.S. Application Data
(60) Provisional application No. 63/170,672, filed on Apr. 5, 2021.

(51) Int. Cl. G06Q 30/02

(52) U.S. Cl. CPC G06Q 30/0254; G06Q 20/127

(57) ABSTRACT

The present invention provides methods and systems for facilitating promotion of a content based on playing an audio. The present invention includes a process of receiving a promotional content from a user device; transmitting the promotional content to a second user device; selecting a promotional content based on the at least one indication; transmitting a promotional content to a promoter device; generating a promotional content notification, wherein the promotional content notification includes statistical representations of the audience data; and transmitting the promotional content notification to the user device, the promoter device and the second user device.

### FIELD OF THE INVENTION

The present invention relates generally to data processing. More specifically, the present invention is methods and systems for facilitating promotion of a content based on playing an audio.

### BACKGROUND OF THE INVENTION

There are over 2 million rideshare drivers in the USA and hundreds of thousands around the world over 60 million use rideshare and over 15,000,000 use rideshare everyday more than 20% of those riders discover music, businesses, and other audio while using the rideshare platform.

Existing techniques for facilitating the promotion of content based on playing the audio are deficient with regard to several aspects. For instance, current technologies do not provide an economical way to promote content at multiple locations. Furthermore, current technologies do not promote the content in multiple locations.

Therefore, there is a need for improved methods and systems for facilitating promotion of a content based on playing an audio that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a method for facilitating promotion of a content based on playing an audio is disclosed. Further, the method may include receiving, using a communication device, user details associated with at least one user from at least one user device. Further, the method may include analyzing, using a processing device, the user details to generate a user account. Further, the method may include receiving, using the communication device, at least one promotional content associated with the at least one user from the at least one user device. Further, the method may include transmitting, using the communication device, at least one rental plan to the at least one user device. Further, the method may include receiving, using the communication device, a selection and a payment corresponding to the at least one rental plan from the at least one user device. Further, the method may include analyzing, using the processing device, the selection and the payment to generate a confirmation. Further, the method may include transmitting, using the communication device, the at least one promotional content to at least one second user device associated with at least one second user device based on the confirmation. Further, the method may include receiving, using the communication device, at least one indication corresponding to each promotional content of the at least one promotional content from the at least one second user device. Further, the method may include selecting, using the processing device, at least one approved promotional content of the at least one promotional content based on the at least one indication. Further, the method may include transmitting, using the communication device, the at least one approved promotional content to at least one promoter device. Further, the method may include receiving, using the communication device, at least one promotional content parameter associated with at least one approved promotional content and audience data from the at least one promoter device. Further, the method may include analyzing, using the processing device, the audience data, the at least one promotional content parameter, and the at least one approved promotional content to generate a promotional content notification. Further, the method may include transmitting, using the communication device, the promotional content notification to the at least one user device and the at least one second user device. Further, the method may include storing, using a storage device, the audience data, the at least one promotional content parameter, and the at least one promotional content, and the promotional content notification.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is an illustration of the present invention in a communication network environment.

FIG. 3 is a simplified flow diagram illustrating example activities or processes an example operation of the present invention.

FIG. 4 is a simplified flow diagram illustrating an indication generating process of the present invention.

FIG. 5 is an illustration showing one embodiment of a user device of the present invention showing the statistical representations.

FIG. 5 is an illustration showing one embodiment of a user device of the present invention showing the statistical representations.

FIG. 6 is a block diagram of a computing device for implementing the present invention disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating promotion of a content based on playing an audio, embodiments of the present disclosure are not limited to use only in this context.

Overview:

The present disclosure describes methods and systems for facilitating promotion of a content based on playing an audio. The present invention may be associated with an online application (or software platform) and may be configured for promoting users such as music artists, comics, businesses, and other audio through rideshare drivers such as Uber™ and Lyft™. When a passenger enters a rideshare vehicle, a driver may play audio, associated with the artists, comics, and businesses, through his or her car radio via Bluetooth or aux.

The present invention may use Wi-Fi and Bluetooth counting technology for recording passenger pick up and drop off for statistics factors and may be configured for automatically detecting potential new listeners of the audio using the Wi-Fi and Bluetooth counting technology. In addition, the present invention may be configured for detecting the audio volume of the audio and the duration of the audio being played.

Further, the disclosed system may be configured for receiving audio from at least one of artists, comics, businesses. Further, representatives associated with the disclosed system may review the audio and approve or reject the audio. Further, the audio may be associated with a genre that may include music, comedy, etc.

Further, the disclosed system may be configured for transmitting the audio to outside content evaluator devices (e.g., smartphones used by 12 random people) that may listen to the genre of the audio and judge to ensure the audio is indeed good and belongs to be software platform and to check the sound quality. The system of the present invention may include preconfigured profiles of the random people and outside content evaluator devices that may be stored in the system of the present invention.

Further, the audio may be censored, thus making the software platform family-friendly. Further, the independent users may make sure the audio is on apps like SHAZAM™. Further, the independent users may submit the audio directly to them. Further, the independent users may upload the audio to distribution websites such as CDBABY™, BELIEVE DIGITAL™, and others. Further, the independent users may make sure your audio is on sites like TIDAL™, SPOTIFY™, iTunes™ etc. When the audio is liked by the passengers, the passenger may tend to turn to these apps to find out who the independent user is to become and fan and purchase the audio. Further, the rideshare partners (or the drivers) may work hard to get the audio heard. Further, the disclosed system may be configured for offering the rideshare partners a rate if they choose to play the audio.

Further, the independent users may launch a campaign on the software platform on any budget, unlike commercial radio you would pay up to $5,000 a week!! And that's just one station and only in one city. When the independent users place a campaign on the software platform, the audio/ad may be visible in multiple cities at the same time.

Further, there are over 2 million rideshare drivers in the USA and hundreds of thousands around the world over 60 million use rideshare and over 15,000,000 use rideshare every day more than 20% of those riders discover music, businesses, and other audio while using the rideshare platform. These are your potential listeners to the audio. Further, if the independent user chooses a subscription program not only the audio continue playing on the software platform, but the independent user may change the audio/ad without paying another platform fee.

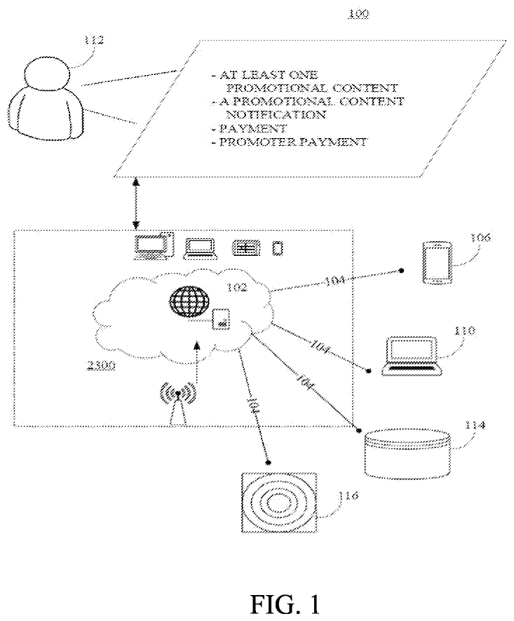

Referring now to figures, FIG. 1 is an illustration of an online platform 100 consistent with various embodiments of the present disclosure. By way of non-limiting example, the online platform 100 for facilitating promotion of a content based on playing an audio may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116, over a communication network 104, such as, but not limited to, the Internet. Further, users of the online platform 100 may include relevant parties such as, but not limited to, end-users, artists, entrepreneurs, and administrators. Accordingly, in some instances, electronic devices operated by the one or more relevant parties may be in communication with the online platform 100.

A user 112, such as the one or more relevant parties, may access the online platform 100 through a web-based software application or browser. The web-based software application may be embodied as, for example, but not be limited to, a website, a web application, a desktop application, and a mobile application compatible with a computing device 2300.

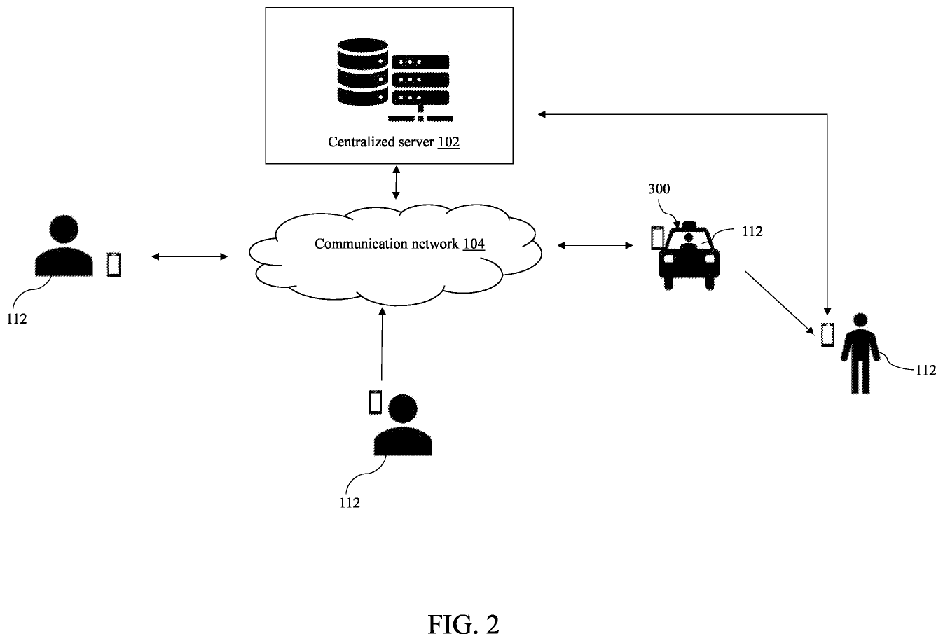

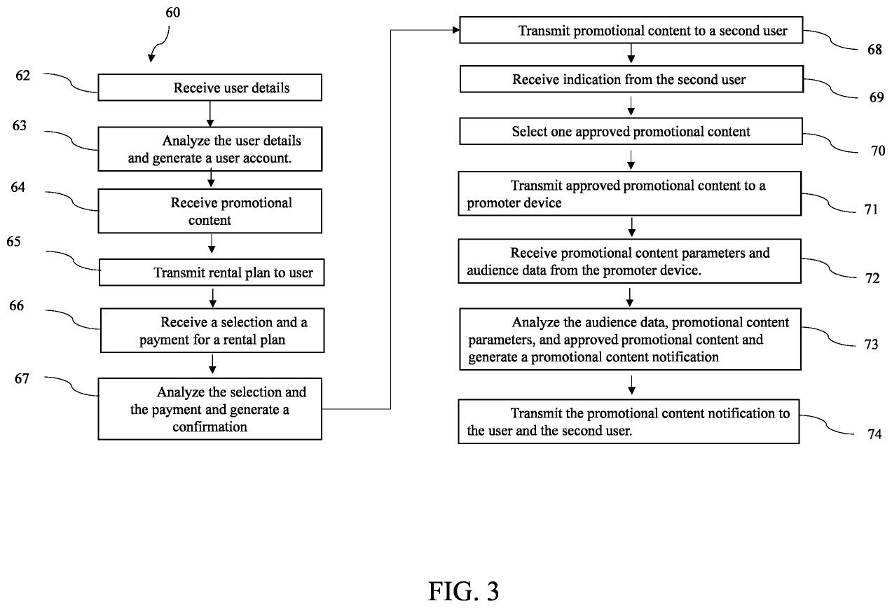

In FIG. 2, a system and method for facilitating promotion of a content based on playing an audio is disclosed. The user 112 of the present invention can be a first user, a second user, a driver, and a passenger. As shown in FIG. 3,

Turning to FIG. 3, FIG. 3 is a simplified flow diagram illustrating example activities or processes of an example operation 60 of the present invention. At 62, the present invention may include a process for receiving, using a communication device, user details associated with at least one first user from at least one first user device. The user details may include a user name, an address, a contact number, a display picture, etc. Further, the at least one first user may include artist, DJ, business, etc.

At 63, the present invention may include a process for analyzing, using a processing device, the user details to generate a user account.

At 64, the present invention may include receiving, using the communication device, at least one promotional content associated with the at least one first user from the at least one first user device. The at least one promotional content may include an audio associated with the at least one first user. The audio may include songs, advertisements, etc.

At 65, the present invention may include transmitting, using the communication device, at least one rental plan to the at least one first user device. The at least one rental plan may include an advertise locally plan, an advertise internationally plan, reach the masses plan, etc. In one embodiment, the at least one rental plan (or campaign package) may include go local package, go mainstream package, and go international package.

At 66, the present invention may include receiving, using the communication device, a selection and a payment corresponding to the at least one rental plan from the at least one first user device.

At 67, the present invention may include analyzing, using the processing device, the selection and the payment to generate a confirmation.

At 68, the present invention may include transmitting, using the communication device, the at least one promotional content to at least one second user device associated with at least one second user device based on the confirmation.

At 69, the present invention may include receiving, using the communication device, at least one indication corresponding to each promotional content of the at least one promotional content from the at least one second user device. In some embodiments (which will be described in detail below), the at least one indication can be received from the outside content evaluator device. The at least one second user may include a customer representative and the at least one second user device may include a smartphone, a tablet, a laptop, a personal computer, and so on. Further, the at least one indication may include one of a positive indication, a negative indication, and an objection indication.

At 70, the present invention may include selecting, using the processing device, at least one approved promotional content of the at least one promotional content based on the at least one indication.

At 71, the present invention may include transmitting, using the communication device, the at least one approved promotional content to at least one promoter device. The at least one promoter device may be associated with at least one promoter that may promote the at least one approved promotional content. The at least one promoter may include a rideshare driver associated with Uber™, Lyft™, etc. and the at least one promoter device may include a smartphone, a tablet, a laptop, a personal computer, and so on.

At 72, the present invention may include receiving, using the communication device, at least one promotional content parameter associated with at least one approved promotional content and audience data from the at least one promoter device. The at least one promotional content parameter may include a number of plays, a duration, volume, etc. associated with the at least one approved promotional content. The audience data may be associated with an audience that may want to play the at least one approved promotional content and the audience may include a passenger. The audience data may include a pick up location, a pick up time, a duration of travel, a drop off time, and a drop off location of the passenger.

At 73, the present invention may include a process for analyzing, using the processing device, the audience data, the at least one promotional content parameter, and the at least one approved promotional content to generate a promotional content notification.

At 74, the present invention may include a process for transmitting, using the communication device, the promotional content notification to the at least one user device and the at least one second user device. In some embodiments, the promotional content notification can also be sent to the promoter device.

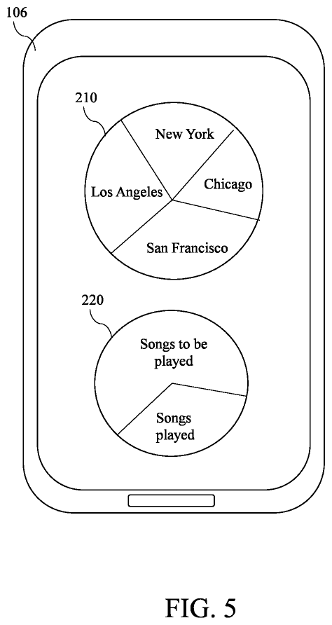

In some embodiments, the promotional content notification, associated with the at least one approved promotional content, may include duration, number of plays, reviews, statistical representations (such as graphs), etc. In such embodiments, the statistical representations may include geographic locations 210 of the drivers and songs played and/or songs to be played 220 as shown in FIG. 5.

In some embodiments, the present invention may include a process for storing, using a storage device, the audience data, the at least one promotional content parameter, and the at least one promotional content, the at least one approved promotional content, and the promotional content notification.

In some embodiments, the present invention may include steps of processing, using the processing device, at least one of the audience data, the at least one promotional content parameter, and the at least one promotional content, the at least one approved promotional content to generate a promoter payment. Further, the promoter may include a reward (or tip/rate) that may be offered to the rideshare driver for promoting the at least one approved promotional content. In yet some other embodiments, the present invention may include a process for transmitting, using the communication device, the promoter payment to the at least one promoter device.

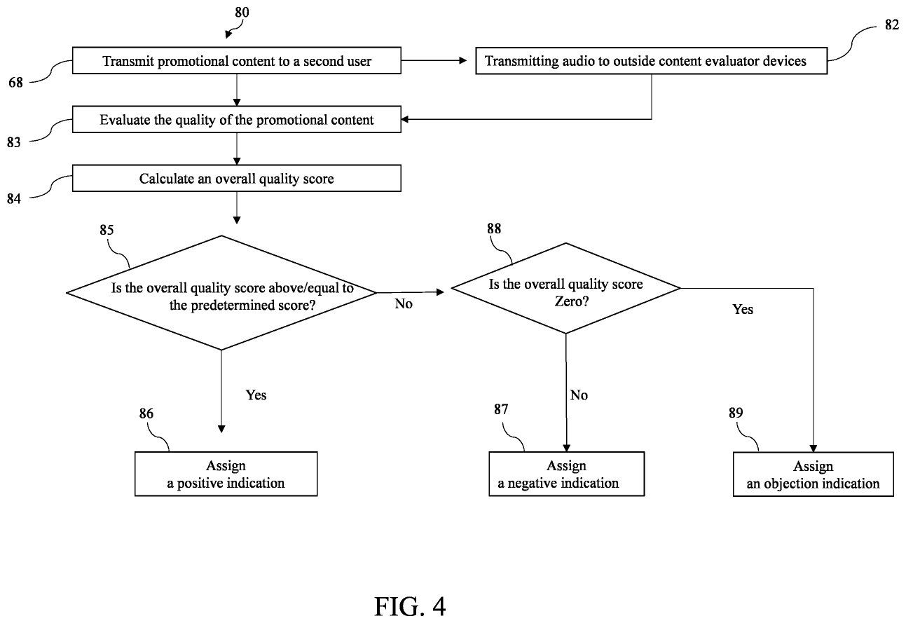

As shown in FIG. 4, in some embodiments, the present invention can include an indication generating process 80 to generate an indication that can be a positive indication, negative indication, or an objection indication.

After transmitting the promotional content to a second user at 68, at 82, the present invention may be configured for transmitting the audio to outside content evaluator devices (e.g., smartphones used by 12 random people) that may listen to the genre of the audio and judge to ensure the audio is indeed good and belongs to be software platform and to check the sound quality. In some embodiments, the present invention may include preconfigured profiles of the random people and outside content evaluator devices that may be stored in the system memory 2304.

At 83, the present invention may be configured to evaluate the quality of the promotional content based on the input from the second user and the outside content evaluators. For example, the second user and the outside content evaluators may send a quality score to calculate an overall quality score at 84 and generate an indication.

For example, the present invention may be configured to transmit at least one promotional content to outside content evaluator devices based on the confirmation, wherein the outside content evaluator devices are included in a preconfigured profile stored in a system memory. The present invention may be configured to receive at least one quality score corresponding to the promotional content from the second user device and the outside content evaluator devices and generate at least one indication based on at least one quality score.

In some embodiments, the present invention may include a predetermined score to determine one of a positive indication, a negative indication, and an objection indication. For example, the present invention may be configured to present the promotional content to the second user and the second user may be allowed to input a quality score after evaluating the quality of the promotional content.

As shown in FIG. 4, at 85, the present invention may include a process to determine if the quality score is above the predetermined score, then the promotional content can be determined as an approved promotional content and the indication can be assigned a negative indication at 86. At 87, if the quality score is below the predetermined score, then the promotional content can be determined as a rejected promotional content and the indication can be assigned a negative indication. At 88, if the quality score is determined to be zero, then the promotional content can be determined as an objected promotional content and the indication can be assigned an objection indication at 89.

In some embodiments, the promoter's car (e.g., a rideshare driver's car) may have a sticker or otherwise displays a QR code that uniquely identifies the driver's car (including the company, driver's name, license number, and plate number). As known to those of skill in the art, a QR code is a two-dimensional bar code capable of encoding data.

In some other embodiments, the QR code may be displayed on the at least one promoter device (driver's phone). In such embodiments, the QR code can be easily changed. In some embodiments, other data encoding schemes and/or plain text can be used in place of the QR code.

In preferred embodiments, the QR code will encode a Uniform Resource Locator (URL). In addition to a domain name, the URL preferably comprises a pick up location, a pick up time, a duration of travel, a drop off time, and a drop off location of the passenger.

After getting into the promoter's car 300, the passenger (user 112) will scan the QR code using his phone (e.g., mobile device 106). The passenger (user 112) can use the camera or other built-in input device on the mobile device 106 to read the QR code. After scanning the QR code, the mobile device 106 can analyze the URL and connect to a web server to identify the promoter's car and the promoter. The web server may provide an interface to the passenger device (passenger's phone) so that the passenger can select one or more of the approved promotional content and provide promotional content parameter and audience data.

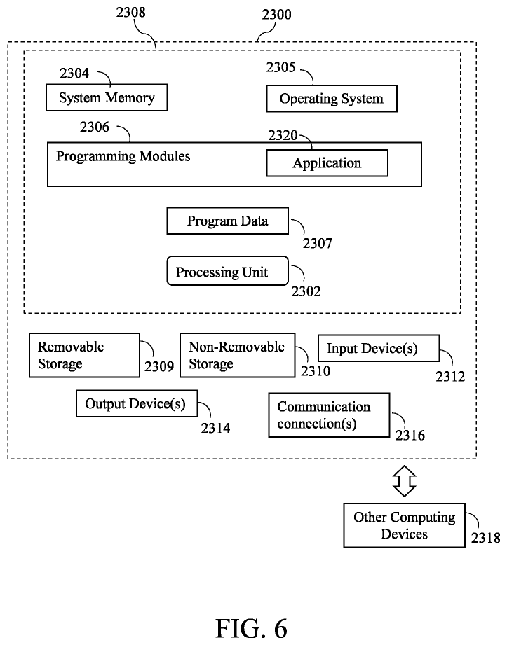

With reference to FIG. 6, a system consistent with an embodiment of the disclosure may include a computing device or cloud service, such as computing device 2300. In a basic configuration, computing device 2300 may include at least one processing unit 2302 and a system memory 2304. Depending on the configuration and type of computing device, system memory 2304 may comprise, but is not limited to, volatile (e.g. random-access memory (RAM)), non-volatile (e.g. read-only memory (ROM)), flash memory, or any combination. System memory 2304 may include operating system 2305, one or more programming modules 2306, and may include a program data 2307. Operating system 2305, for example, may be suitable for controlling computing device 2300's operation. In one embodiment, programming modules 2306 may include image-processing module, machine learning module and/or image classifying module. Furthermore, embodiments of the disclosure may be practiced in conjunction with a graphics library, other operating systems, or any other application program and is not limited to any particular application or system. This basic configuration is illustrated in FIG. 6 by those components within a dashed line 2308.

Computing device 2300 may have additional features or functionality. For example, computing device 2300 may also include additional data storage devices (removable and/or non-removable) such as, for example, magnetic disks, optical disks, or tape. Such additional storage is illustrated in FIG. 6 by a removable storage 2309 and a non-removable storage 2310. Computer storage media may include volatile and nonvolatile, removable and non-removable media implemented in any method or technology for storage of information, such as computer-readable instructions, data structures, program modules, or other data. System memory 2304, removable storage 2309, and non-removable storage 2310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2300. Any such computer storage media may be part of device 2300. Computing device 2300 may also have input device(s) 2312 such as a keyboard, a mouse, a pen, a sound input device, a touch input device, a location sensor, a camera, a biometric sensor, etc. Output device(s) 2314 such as a display, speakers, a printer, etc. may also be included. The aforementioned devices are examples and others may be used.

Computing device 2300 may also contain a communication connection 2316 that may allow device 2300 to communicate with other computing devices 2318, such as over a network in a distributed computing environment, for example, an intranet or the Internet. Communication connection 2316 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 2304, including operating system 2305. While executing on processing unit 2302, programming modules 2306 (e.g., application 2320 such as a media player) may perform processes including, for example, one or more stages of methods, algorithms, systems, applications, servers, databases as described above. The aforementioned process is an example, and processing unit 2302 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A method comprising:
receiving user details associated with at least one user device;
analyzing the user details;
generating a user account;
receiving at least one promotional content;
transmitting at least one rental plan to the at least one user device;
receiving a selection and a payment corresponding to the at least one rental plan;
analyzing the selection and the payment to generate a confirmation;
transmitting the at least one promotional content to at least one second user device based on the confirmation;
transmitting the at least one promotional content to outside content evaluator devices based on the confirmation, wherein the outside content evaluator devices are included in a preconfigured profile stored in a system memory;
receiving at least one quality score corresponding to the at least one promotional content from the at least one second user device and the outside content evaluator devices;
generating at least one indication based on the at least one quality score;
selecting at least one promotional content based on the at least one indication;
transmitting the at least one promotional content to at least one promoter device;
providing a QR code configured to be scanned by a second user;
receiving at least one promotional content parameter associated with at least one promotional content and audience data;
analyzing the audience data, the at least one promotional content parameter, and the at least one promotional content;
generating a promotional content notification, wherein the promotional content notification includes statistical representations of the audience data and the at least one promotional content parameter; and
transmitting the promotional content notification to the at least one user device, the at least one promoter device and the at least one second user device.

2. The method as claimed in claim 1, wherein the method comprising reviving an advertisement from the at least one user device and displaying the advertisement on the at least one promoter device.

3. The method as claimed in claim 1, wherein the QR code is placed in a sticker.

4. The method as claimed in claim 1, wherein the QR code includes a name, license number and a plate number associated with a driver.

5. The method as claimed in claim 1, wherein the QR code includes a Uniform Resource Locator, a pick up location, a pick up time, a duration of travel, a drop off time, and a drop off location of a passenger.

6. The method as claimed in claim 1, wherein the statistical representations include geographic locations of the promoter device.

7. The method as claimed in claim 1, wherein the promotional content notification includes reviews.

8. A non-transitory computer readable medium containing computer-readable instructions stored therein for causing a computer processor to perform operations to:
receive user details associated with at least one user device;
analyze the user details;
generate a user account;
receive at least one promotional content;
transmit at least one rental plan to the at least one user device;
receive a selection and a payment corresponding to the at least one rental plan;
analyze the selection and the payment to generate a confirmation;
transmit the at least one promotional content to at least one second user device based on the confirmation;
transmit the at least one promotional content to outside content evaluator devices based on the confirmation, wherein the outside content evaluator devices are included in a preconfigured profile stored in a system memory;
receive at least one quality score corresponding to the at least one promotional content from the at least one second user device and the outside content evaluator devices;
generate at least one indication based on the at least one quality score;
receive at least one indication corresponding to the at least one promotional content from the at least one second user device;
select at least one promotional content based on the at least one indication;
transmit the at least one promotional content to at least one promoter device;
provide a QR code configured to be scanned by a second user;
receive at least one promotional content parameter associated with at least one promotional content and audience data;
analyze the audience data, the at least one promotional content parameter, and the at least one promotional content;
generate a promotional content notification, wherein the promotional content notification includes statistical representations of the audience data and the at least one promotional content parameter; and
transmit the promotional content notification to the at least one user device, the at least one promoter device and the at least one second user device.

9. The non-transitory computer readable medium as claimed in claim 8, wherein the QR code is placed in a sticker.

10. The non-transitory computer readable medium as claimed in claim 8, wherein the QR code includes a name, license number and a plate number associated with a driver.

11. The non-transitory computer readable medium as claimed in claim 8, wherein the QR code includes a Uniform Resource Locator, a pick up location, a pick up time, a duration of travel, a drop off time, and a drop off location of a passenger.

12. The non-transitory computer readable medium as claimed in claim 8, wherein the statistical representations include geographic locations of the promoter device.

13. The non-transitory computer readable medium as claimed in claim 8, wherein the promotional content notification includes reviews.

14. A non-transitory computer readable medium containing computer-readable instructions stored therein for causing a computer processor to perform operations to:
receive user details associated with at least one user device;
analyze the user details;
generate a user account;
receive at least one promotional content;
transmit at least one rental plan to the at least one user device;
receive a selection and a payment corresponding to the at least one rental plan;
analyze the selection and the payment to generate a confirmation;
transmit the at least one promotional content to at least one second user device based on the confirmation;
transmit the at least one promotional content to outside content evaluator devices based on the confirmation, wherein the outside content evaluator devices are included in a preconfigured profile stored in a system memory;
receive at least one quality score corresponding to the at least one promotional content from the at least one second user device and the outside content evaluator devices;
generate at least one indication based on the at least one quality score;
receive at least one indication corresponding to the at least one promotional content from the at least one second user device;
select at least one promotional content based on the at least one indication;
transmit the at least one promotional content to at least one promoter device;
provide a QR code configured to be scanned by a second user;
receive at least one promotional content parameter associated with at least one promotional content and audience data;
analyze the audience data, the at least one promotional content parameter, and the at least one promotional content;
generate a promotional content notification, wherein the promotional content notification includes statistical representations of the audience data and the at least one promotional content parameter, wherein the statistical representations include geographic locations of the promoter device; and
transmit the promotional content notification to the at least one user device, the at least one promoter device and the at least one second user device.

15. The non-transitory computer readable medium as claimed in claim 14, wherein the QR code is placed in a sticker.

16. The non-transitory computer readable medium as claimed in claim 14, wherein the QR code includes a name, license number and a plate number associated with a driver.

17. The non-transitory computer readable medium as claimed in claim 14, wherein the QR code includes a Uniform Resource Locator, a pick up location, a pick up time, a duration of travel, a drop off time, and a drop off location of a passenger.

18. The non-transitory computer readable medium as claimed in claim 14, wherein the QR code is placed in a sticker attached on a car window.

19. The non-transitory computer readable medium as claimed in claim 14, wherein the QR code is displayed on the promoter device.

20. The non-transitory computer readable medium as claimed in claim 14, wherein the at least one promotional content parameter includes a number of plays, a duration, and volume.
